(19) United States
(12) Patent Application Publication
(10) Pub. No.: US 2014/0106259 A1
(43) Pub. Date: Apr. 17, 2014

(54) POSITIVE ELECTRODE COMPOSITE FOR SOLID OXIDE FUEL CELL, METHOD OF PREPARING THE SAME AND SOLID OXIDE FUEL CELL INCLUDING THE SAME

(71) Applicant: SAMSUNG ELECTRONICS CO., LTD., Suwon-si (KR)

(72) Inventors: Chan KWAK, Yongin-si (KR); Hee-jung PARK, Suwon-si (KR); Dong-hee YEON, Seoul (KR); Zongping SHAO, Nanjing (CN); Dengjie CHEN, Nanjing (CN); Fucheng WANG, Nanjing (CN)

(73) Assignee: SAMSUNG ELECTRONICS CO., LTD., Suwon-si (KR)

(21) Appl. No.: 13/887,543

(22) Filed: May 6, 2013

(30) Foreign Application Priority Data
Oct. 16, 2012 (KR) 10-2012-0115031

(51) Int. Cl. H01M 4/90; H01M 4/88

(52) U.S. Cl. CPC H01M 4/9033; H01M 4/8882
USPC 429/527; 429/523; 429/528; 427/115

(57) ABSTRACT

A positive electrode composite for a solid oxide fuel cell, on the positive electrode composite including: a porous reaction prevention layer; and a mixed-conductivity material disposed in the porous reaction prevention layer.

### CROSS-REFERENCE TO RELATED APPLICATIONS

This application claims priority to Korean Patent Application No. 10-2012-0115031, filed on Oct. 16, 2012, and all the benefits accruing therefrom under 35 U.S.C. §119, the content of which in its entirety is herein incorporated by reference.

### BACKGROUND

1. Field

The present disclosure relates to positive electrode composites for solid oxide fuel cells, and more particularly, to positive electrode composites for solid oxide fuel cells having a long term durability and excellent output density at a low operating temperature.

2. Description of the Related Art

A solid oxide fuel cell (SOFC) is a highly efficient and environmentally friendly electrochemical power generation device that directly converts the chemical energy of fuel gas into electrical energy. The SOFC includes inexpensive materials, has high permissibility to fuel impurities, and has hybrid power generation capability and high efficiency compared to other fuel cells. The use of a SOFC may result in simplification and price lowering of a fuel cell system because hydrocarbon fuel is directly used without being converted to hydrogen. The SOFC includes a negative electrode where a fuel such as hydrogen or hydrocarbon is oxidized, a positive electrode where oxygen gas is reduced to an oxygen ion (O²⁻), and a solid electrolyte that conducts the oxygen ion.

Because existing SOFCs operate in a high temperature range of about 800 to about 1,000° C., they include materials such as high temperature alloys or expensive ceramic materials that may sustain such high temperatures. However, systems including SOFCs have problems such as a long start-up time and a decline in the durability of materials when used for a long time. Also, high cost is an obstacle in the commercialization of SOFCs.

Accordingly, much research has been conducted to lower the operating temperature of SOFCs below 800° C. However, lowering the operating temperature rapidly increases the electric resistance of the SOFC materials and this eventually acts as the main cause of the decrease in the output density of the SOFCs. Because the decrease in the operating temperature of the SOFCs is largely affected by the magnitude of a positive electrode resistance, global action has been undertaken to decrease the positive electrode resistance.

Positive electrode materials for operating at a low temperature include LaSrCoFeO (“LSCF”), SmSrCoO (“SSC”), BaSrCoFeO (“BSCF”), and these materials react with ZrO₂-based materials used as an electrolyte to create a non-conducting layer. To prevent this phenomenon, a CeO₂-based material is inserted between the electrolyte and a positive electrode layer as a reaction prevention layer. However, in this case, the thermal expansion coefficient of the positive electrode layer is significantly different from the thermal expansion coefficient of the electrolyte, and this difference is the main reason for the reduction of long term durability.

### SUMMARY

Provided is a positive electrode composite for a solid oxide fuel cell with improved long term durability.

Provided is a method of preparing a positive electrode composite for a solid oxide fuel cell.

Provided is a solid oxide fuel cell with excellent reliability and high output density at a low operating temperature.

Additional aspects will be set forth in part in the description which follows and, in part, will be apparent from the description, or may be learned by practice of the presented embodiments.

According to an aspect, a positive electrode composite for a solid oxide fuel cell includes: a porous reaction prevention layer; and a mixed-conductivity material disposed on the porous reaction prevention layer.

According to another aspect, a method of manufacturing a positive electrode composite for a solid oxide fuel cell includes: providing a solution including a precursor of a mixed-conductivity material; disposing the solution on a porous reaction prevention layer to impregnate the porous reaction preventing layer with the precursor of the mixed-conductivity material; and heat treating the porous reaction prevention layer with the precursor of the mixed-conductivity material to manufacture the positive electrode composite.

According to another aspect, a solid oxide fuel cell includes: the positive electrode composite disclosed above, a negative electrode; and a solid electrolyte disposed between the positive electrode composite and the negative electrode.

### BRIEF DESCRIPTION OF THE DRAWINGS

These and/or other aspects will become apparent and more readily appreciated from the following description of the embodiments, taken in conjunction with the accompanying drawings in which:

FIG. 1 is a scanning electron microscope (SEM) image of a cross-section of a porous reaction prevention layer according to Example 1;

FIG. 2 is a scanning electron microscope image of a cross-section of a porous reaction prevention layer according to Example 4;

FIG. 3 is a scanning electron microscope image of a cross-section of a positive electrode composite according to Example 1;

FIG. 4A is a scanning electron microscope image of a cross-section of a positive electrode composite according to Example 2, and FIG. 4B is a magnified image of FIG. 4A by 10 times;

FIG. 5 is a scanning electron microscope image of a cross-section of the positive electrode composite prepared in Example 1;

FIG. 6 is a graph of coefficient of thermal expansion (change in length/original length %, dL/Lₒ%) versus temperature (° C.) showing the coefficients of thermal expansion of a positive electrode composite comprising a porous reaction prevention layer prepared in Example 3 and a positive electrode layer prepared in Comparative Example 2;

FIG. 7 is a graph of log conductivity (Siemens per centimeter, S·cm⁻¹) versus temperature (° C.) showing the electrical conductivity of a test cell of Examples 5 to 7.

FIG. 8 is a graph of impedance (ohms-square centimeters, Ωcm²) versus temperature (° C.) showing the resistance and resistance stability of a test cell prepared in Example 8 and Comparative Examples 1 and 2; and

FIGS. 9A, 9B and 9C are graphs of voltage (volts, V) and power density (milliWatts per square centimeter, mW·cm⁻²) versus current density (milliAmperes per square centimeter, mA·cm⁻²) showing the current-voltage curve and output density of a cell prepared in Example 8 and Comparative Examples 1 and 2 respectively.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an” and “the” are intended to include the plural forms as well, unless the context clearly indicates otherwise. The term “or” means “and/or.” As used herein, the term “and/or” includes any and all combinations of one or more of the associated listed items. Expressions such as “at least one of,” when preceding a list of elements, modify the entire list of elements and do not modify the individual elements of the list.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Mixture” as used herein is inclusive of all types of combinations, including blends, alloys, solutions, and the like.

“Impregnated on a porous reaction prevention layer” as used herein means to dispose on, e.g., permeate, a porous reaction prevention layer.

A “perovskite metal oxide” means a metal oxide having a perovskite-type crystal structure.

Hereinafter, one or more embodiments of a positive electrode composite for a solid oxide fuel cell will be described in greater detail.

While not wanting to be bound by theory, it is understood that the “reaction prevention layer” prevents or suppresses a reaction between positive electrode active materials and an electrolyte.

The “positive electrode composite” as used herein comprises a positive electrode active material and a reaction preventing material disposed thereon, and may comprise a mixture of positive electrode active materials and reaction prevention materials, or may comprise a positive electrode active material disposed on, e.g., impregnated on the reaction prevention layer. The positive electrode composite refers to materials that may be used as a positive electrode.

According to one aspect, a positive electrode composite for a solid oxide fuel cell includes a porous reaction prevention layer and a mixed-conductivity material impregnated on the porous reaction prevention layer.

According to one aspect, a mixed-conductivity material is impregnated on a porous reaction prevention layer, the mixed-conductivity material may simultaneously perform a reaction prevention role and a positive electrode active material role in a double layer structure made of a reaction prevention layer and a positive electrode layer. Accordingly, and while not wanting to be bound by theory, due to an increase in a size of the triple phase boundary, the cell efficiency may improve. Also problems caused by the difference in the coefficients of thermal expansion of the positive electrode layer and an electrolyte may be solved and a more stable solid oxide fuel cell may be obtained even for a long term use.

The porous reaction prevention layer may have porosity of about 35% to about 60%. When the porosity is within this range, the mixed-conductivity material may connect to one another in a reaction prevention layer such that a sufficient electrical conductivity may be obtained for a positive electrode.

The porous reaction prevention layer may have an average pore diameter of about 200 nanometers (nm) to about 1 micrometer (μm). When the average pore diameter is within this range, the mixed-conductivity material may easily impregnate when in a particle form.

The mixed-conductivity material may have a pore diameter smaller than 100 μm. For example, the pore diameter may be about 50 μm to about 60 μm. When the pore diameter is within this range, due to an increase in the triple phase boundary, a solid oxide fuel cell with excellent efficiency may be provided.

The mixed-conductivity material are mixed ionic and electronic conductor materials (“MIEC”) having both ion conductivity and electron conductivity. The mixed-conductivity material has a high oxygen diffusion coefficient and a high electric charge exchange reaction velocity coefficient. Hence, the mixed-conductivity material may contribute to a decrease in the operating temperature of the solid oxide fuel cell. The exceptional electrode activity at a low temperature may be due to an oxygen reduction reaction at the triple phase boundary and on the surface of an entire electrode. The mixed-conductivity material may comprise a Perovskite-based metal oxide. The Perovskite-based metal oxide may include a compound represented by Formula 1 below.

AMO_{3±γ} Formula 1

wherein, A is one or more elements of La, Ba, Sr, Sm, Gd, and Ca,
M is one or more elements of Mn, Fe, Co, Ni, Cu, Ti, Nb, Cr, and Sc,
γ denotes oxygen excess or oxygen shortage and may be 0≦γ0.3.

For example, a Perovskite-based metal oxide may include a compound represented by Formula 2 below.

A′₁₋ₓA″ₓM′O_{3±γ} Formula 2

In the above equation, A′ is one or more elements of Ba, La and Sm,
A″ is one or more elements of Sr, Ca and Ba and is different from A′,
M′ is one or more elements of Mn, Fe, Co, Ni, Cu, Ti, Nb, Cr and Sc, 0≦x≦1,
γ denotes oxygen excess or oxygen shortage and may be 0≦γ≦0.3.

Examples of a Perovskite-based metal oxide include barium strontium cobalt iron oxide (“BSCF”), lanthanum strontium cobalt oxide (“LSC”), lanthanum strontium cobalt iron oxide (“LSCF”), lanthanum strontium cobalt manganese oxide (“LSCM”), lanthanum strontium iron oxide (“LSF”), and samarium strontium cobalt oxide (“SSC”).

In greater detail, examples of a Perovskite-based metal oxide include Ba₁₋ₓSrₓCo_{1-y}Fe_{y}O_{3±γ} wherein, 0.1≦x≦0.5, 0.05≦y≦0.5, and 0≦γ≦0.3, La₁₋ₓSrₓFe_{1-y}Co_{y}O_{3±γ}wherein, 0.1≦x≦0.4, 0.05≦y≦0.5, and 0≦γ≦0.3, Sm₁₋ₓSrₓCoO_{3±γ} wherein, 0.1≦x≦0.5, and 0≦γ≦0.3. For example, oxides such as Ba_{0.5}Sr_{0.5}Co_{0.8}Fe_{0.2}O₃, La_{0.6}Sr_{0.4}Co_{0.2}Fe_{0.8}O₃, and Sm_{0.5}Sr_{0.5}CoO₃ may be used.

Also, a mixed-conductivity metal oxide may include a Perovskite-based metal oxide comprising a compound represented by Formula 3 below:

BaₐSr_{b}CoₓFe_{y}Z_{1-x-y}O_{3±γ} Formula 3

wherein, 0.4≦a≦0.6, 0.4≦b≦0.6, 0.6≦x<0.9, 0.1≦y<0.4, x+y<1, Z is one or more element of transition metal elements and lanthanum elements, and 0≦γ≦0.3.

The transition metal elements included in Z of Formula 3 represent elements from Groups 3 to 12 of the periodic table. The term “transition metal elements” excludes lanthanum group elements. The transition metal elements may include at least one selected from manganese, zinc, nickel, titanium, niobium, and copper, but are not limited thereto.

The lanthanum group elements included in Z of Formula 3 include elements of atomic numbers 57 to 70. For example, one or more of holmium, ytterbium, erbium, and thulium may be used, but are not limited thereto.

The Perovskite-based metal oxides may include a compound of Formula 4:

Ba_{0.5}Sr_{0.5}CoₓFe_{y}Z_{1-x-y}O_{3±γ}, Formula 4

wherein, Z represents at least one of transition metal elements and lanthanum elements, each of x and y has a range of 0.75≦x≦0.85, 0.1≦y≦0.15, respectively, x+y<1, and 0≦γ≦0.3.

For example, Ba_{0.5}Sr_{0.5}CO_{0.8}Fe_{0.1}Z_{0.1}O₃ wherein, Z is at least one of Mn, Zn, Ni, Ti, Nb and Cu.

These Perovskite-based metal oxides may be used alone or as a mixture of two or more of these oxides.

According to one aspect, the amount of mixed-conductivity material in a positive electrode composite for a solid oxide fuel cells may be present in a range of about 20 weight % to about 50 weight percent (weight %), based on a total weight of the positive electrode composite.

A porous reaction prevention layer is selected from one or more of gadolinium-doped ceria (“GDC”), samarium-doped ceria (“SDC”), and yttrium-doped ceria (“YDC”).

The mixed-conductivity material may have an average diameter about 100 nm or less, for example, average pore diameter of about 50 to about 60 nm. Due to these average diameters, it is possible to increase an active site concentration for oxygen reduction reaction.

Hereinafter, a method of manufacturing a positive electrode composite for solid oxide fuel cells according to one aspect will be described in detail.

According to one aspect, the method of manufacturing includes: forming a solution comprising a precursor of a mixed-conductivity material; disposing the solution in a porous reaction preventing layer, e.g., impregnating a porous reaction prevention layer with the solution; and heat treating the porous reaction prevention layer impregnated with the solution to manufacture the positive electrode composite.

The precursor of the mixed-conductivity material may be selected from a nitride, oxide, and halide of the metal in the mixed-conductivity material.

The porous reaction prevention layer may be manufactured by adding pore formers to the reaction prevention layer material and calcining the same. The calcination temperature may be about 1100 to about 1400° C.

The pore formers may be selected from starch, polyvinylbutyral (“PVB”), and graphite.

The amount of pore formers added to the reaction prevention layer material may be about 5 to about 20 parts by weight per 100 parts by weight of the reaction prevention layer material. If the amount of pore formers is within this range, sufficient amount of the mixed-conductivity material may be impregnated and the strength of the reaction prevention layer may be maintained.

The porous reaction prevention layer impregnated with the precursors of mixed-conductivity material may be heated at about 900° C. to about 1100° C. to provide a positive electrode composite with a porous reaction prevention layer impregnated with the mixed-conductivity material.

The amount of precursors of the mixed-conductivity material used may be such that the amount of the mixed-conductivity material in the positive electrode composite is in a range of about 20 wt % to about 50 wt %, based on a total weight of the positive electrode composite. Water may be used as a solvent in forming the solution including the mixed-conductivity material, but the present invention is not limited thereto.

The solution manufacturing process is performed at temperature of about 100° C. to about 200° C. and the solution is stirred for a time to sufficiently mix each component.

According to another aspect, a solid oxide fuel cell includes a positive electrode composite; a negative electrode; and a solid electrolyte layer disposed between the positive electrode composite and the negative electrode

As it is desirable for the electrolyte layer to have a high density quality, sintering treatment may be performed at a high temperature for a long time. For example, the sintering may be performed under the temperature range of about 1,450° C. to about 1,550° C. for 6 to 8 hours.

The positive electrode composite reduces oxygen gas to oxygen ions, and air is constantly provided to the positive electrode composite to maintain a constant oxygen partial pressure. The mixed-conductivity material included in the positive electrode composite are mixed ionic and electronic conductor materials that have ion conductivity and electronic conductivity, a high oxygen diffusion coefficient, and a high velocity coefficient of electric charge exchange reaction. Thus, the positive electrode composite may lower the operating temperature of the SOFC due to exceptional electrode activity at a low temperature because of an oxygen reduction reaction in the triple phase boundary and the entire electrode surface. The mixed-conductivity material may comprise a Perovskite-based metal oxide, which includes a compound represented by Formula 1.

AMO_{3±γ} Formula 1

wherein, A is one or more elements selected from La, Ba, Sr, Sm, Gd, and Ca,
M is one or more elements selected from Mn, Fe, Co, Ni, Cu, Ti, Nb, Cr, and Sc,
γ represents oxygen excess or oxygen shortage and may be 0≦γ≦0.3.

For example, the Perovskite-based metal oxide may include a compound represented by Formula 2.

A′₁₋ₓA″xM′O3_{±γ} Formula 2

wherein, A′ is one or more elements selected from Ba, La, and Sm,
A″ is an element selected from at least Sr, Ca, and Ba, and is different from A′,
M′ is one or more elements selected from Mn, Fe, Co, Ni, Cu, Ti, Nb, Cr, and Sc, 0≦x≦1,
γ represents oxygen excess or oxygen shortage, and may be 0≦γ≦0.3.

Examples of the Perovskite-based metal oxide include, barium strontium cobalt iron oxide (“BSCF”), lanthanum strontium cobalt oxide (“LSC”), lanthanum strontium cobalt iron oxide (“LSCF”), lanthanum strontium cobalt manganese oxide (“LSCM”), lanthanum strontium iron oxide (“LSF”), and samarium strontium cobalt oxide (“SSC”).

In greater detail, examples of the Perovskite-based metal oxide include at least one selected from Ba₁₋ₓSrₓCo_{1-y}Fe_{y}O_{3±γ} wherein, 0.1≦x≦0.5, 0.05≦y≦0.5, and 0≦γ≦0.3, La₁₋ₓSrₓFe_{1-y}Co_{y}O_{3±γ} wherein, 0.1≦x≦4, 0.05≦y≦0.5, and 0≦γ≦0.3, Sm₁₋ₓSrₓCoO_{3±γ} wherein, 0.1≦x≦0.5, and 0≦γ≦0.3. For example, Ba_{0.5}Sr_{0.5}CO_{0.8}Fe_{0.2}O₃, La_{0.6}Sr_{0.4}Co_{0.2}Fe_{0.8}O₃, and Sm_{0.5}Sr_{0.5}CoO₃ oxides may be used.

Also, the Perovskite-based metal oxide includes a compound represented in Formula 3 mixed-conductivity:

BaₐSr_{b}CoₓFe_{y}Z_{1-x-y}O_{3±γ} Formula 3

wherein, 0.4≦a≦0.6, 0.4≦b≦0.6, 0.6≦x<0.9, 0.1≦y<0.4, x+y<1, Z is at least one element selected from transition metal elements and lanthanum group elements, and 0≦γ≦0.3.

The transition metal element Z of the above Formula 3 denotes elements from Groups 3 to 12 of the periodic table and excludes lanthanum-based elements from the transition metal elements in this specification. Examples of these transition metals include manganese, zinc, nickel, titanium, niobium, and copper, but not limited thereto.

The lanthanum group elements included in Z of Formula 3 include at least one element with atomic numbers 57 to 70. For example, at least one of holmium, ytterbium, erbium, and thulium may be used, but the present invention is not limited thereto.

The Perovskite-based metal oxide may include a compound of Formula 4 below:

Ba_{0.5}Sr_{0.5}CoₓFe_{y}Z_{1-x-y}O_{3±γ} Formula 4

wherein, Z represents at least one element selected from transition metal elements and lanthanum group elements, x and y have a range of 0.75≦x≦0.85, 0.1≦y≦0.15, respectively, x+y<1, and 0≦γ≦0.3.

For example, Ba_{0.5}Sr_{0.5}CO_{0.8}Fe_{0.1}Z_{0.1}O₃ wherein, Z includes at least one of Mn, Zn, Ni, Ti, Nb and Cu.

These Perovskite-based metal oxides may be used alone or as a mixture of two or more groups.

The thickness of the positive electrode composite layer is usually about 1 to about 100 μm. For example, the thickness may be in a range of about 5 to about 50 μm.

A solid oxide electrolyte is made with precision such that air and fuel do not mix, has high oxygen ion conductivity and low electronic conductivity. Also, because there are positive electrode and negative electrode with large oxygen partial pressure differential in the electrolyte, the properties of the positive electrode composite layer are maintained even in a broad range of oxygen partial pressures.

Materials such as zirconium group material, or a ((La, Sr)(Ga, Mg)O₃ (“LGSM”) may be used to form the solid oxide electrolyte.

For example, stabilized zirconia such as yttria-stabilized zirconia (“YSZ”), or scandia-stabilized zirconia (“ScSZ”) may be used. Also, regarding the ((La, Sr)(Ga, Mg)O₃ (“LGSM”) group, to prevent a reaction with Ni, positive electrode functional layers such as GDC may be included.

The thickness of the solid oxide electrolyte may be about 10 nm to about 100 μm. For example, the thickness may be in a range of about 100 nm to about 50 μm.

A negative electrode electrochemically oxidizes and transfers electric charges of fuel. Thus, a negative electrode catalyst has a fuel oxidation catalyst property and is chemically stable with respect to the electrolyte materials and has similar thermal expansion coefficient as the electrolyte materials. The negative electrode may include at least one of a cermet, a mixture of materials that include solid oxide electrolyte and nickel oxide. For example, when YSZ is used as an electrolyte, Ni/YSZ composite (ceramic-metallic composite) may be used. Furthermore, Ru/YSZ cermet or pure metals such as Ni, Co, Ru, and Pt may be used as the negative electrode materials, but are not limited thereto. The negative electrode may additionally include active carbon that may be porous such that fuel gas may be well distributed.

The thickness of the negative electrode may be in a range of about 1 μm to about 1000 μm. For example, the thickness of the negative electrode may be in a range of about 5 μm to about 100 μm.

According to one aspect, the solid oxide fuel cell may additionally include an electricity current collector located on the outer surface of the positive electrode composite, which includes an electronic conductor. The current collector may be an electricity current collector of the positive electrode composite.

The electricity current collector may include at least one of the groups of, for example, lanthanum cobalt oxide (LaCoO₃), lanthanum strontium cobalt oxide (“LSC”), lanthanum strontium cobalt iron oxide (LSCF), lanthanum strontium cobalt manganese oxide (“LSCM”), lanthanum strontium manganese oxide (“LSM”), and lanthanum strontium iron oxide (“LSF”). The electricity current collector may include only one of the materials listed above, or a mixture of two or more materials. Also, it is possible to make a single layer or multiple layer structures with two or more layers using these materials.

Since the solid oxide fuel cell may be manufactured using a general method well known in the field, a detailed description about it will be omitted. Also, the solid oxide fuel cell may be formed in various structures such as a tubular stack, a flat tubular stack, and a planar-type stack.

According to one aspect, a fuel cell may have a constant resistance property at a low temperature, while at the same time prevent thermal expansion of the positive electrode active materials, minimize thermal maladjustment between the layers thereby having increased durability.

The fuel cell may be used at a temperature below 800° C., for example, in a temperature range of about 550° C. to about 750° C., or about 600° C. to about 750° C. As a result, a high ion conductivity may be maintained at a low temperature while preventing thermal expansion of a positive electrode active material in order to minimize thermal maladjustment between the layers of a battery including the solid oxide fuel cell, so that the stability and durability of the solid oxide fuel are increased.

The present invention will now be described in greater detail with reference to the following examples. However, the following examples are for illustrative purposes only and are not intended to limit the scope.

### EXAMPLES

### Example 1

Test cells were manufactured. A negative electrode layer, an electrolyte layer, a reaction prevention layer and a positive electrode layer were manufactured in the stated order.

To manufacture a negative electrode layer in pellet form, 0.5 g of yttrium-stabilized zirconia (“YSZ”), (Y_{0.2}Zr_{0.8}O₂)—NiO powder (FCM, USA) was added into a mold with a diameter of 1 centimeter (cm), uniaxially pressed at approximately 200 megaPascals (MPa) and calcined at a temperature of 1200° C. for 2 hours.

Ethanol dispersed yttrium-stabilized zirconia was drop coated on the negative electrode layer and sintered at 1400° C. for 4 hours. The thickness of the manufactured electrolyte layer was 15 μm.

Samarium-doped ceria (“SDC”)(Sm_{0.1}Ce_{0.9}O₂) (FCM, USA) was used as a material for a porous reaction prevention layer.

After mixing SDC and polyvinylbutyral in 9:1 ratio, the mixture was screen printed on the electrolyte. After printing, the mixture was calcined at 1250° C. for 5 hours. The porosity was approximately 50% and the thickness of the porous reaction prevention layer was 30 μm.

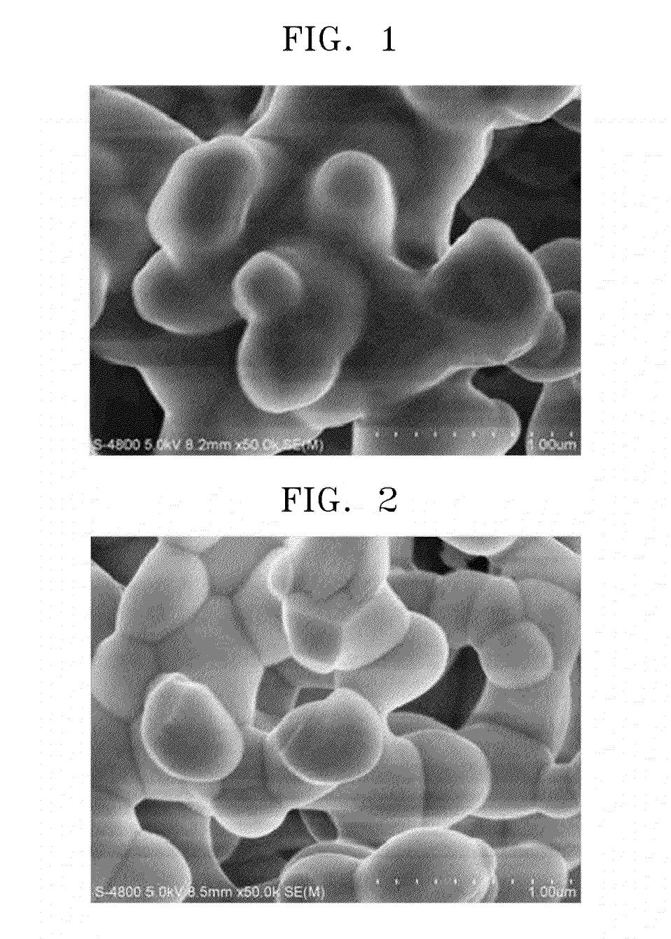

FIG. 1 is a scanning electron microscope image of a cross-section of the manufactured porous reaction prevention layer. As shown in FIG. 1, an SDC frame structure with pores was obtained.

Sm_{0.5}Sr_{0.5}CoO₃ was prepared for use as a mixed-conductivity material.

First, nitrides of each metal were quantified in accordance with the molar ratio according to the formula Sm_{0.5}Sr_{0.5}CoO₃, mixed with 10 milliliters (mL) of water and stirred at a temperature of 20° C. for 1 hour to obtain a precursor solution of the mixed-conductivity materials.

The prepared aqueous solution of the precursor of the mixed-conductivity materials was mixed with water in a 1:1 ratio and impregnated on the porous reaction prevention layer.

The porous reaction prevention layer impregnated with the precursor of the mixed-conductivity material was heat treated at a temperature of about 900° C. for 4 hours and a composite layer, i.e., a positive electrode composite, comprised of a SDC layer impregnated with 10 wt % of SSC was obtained.

### Example 2

A positive electrode composite and a test cell including the positive electrode composite was manufactured in the same manner as in Example 1, except for mixing the aqueous solution of the precursor of the mixed-conductivity material and water in a 2:1 ratio and impregnating on the porous reaction prevention layer (20 wt % of impregnation).

### Example 3

A positive electrode composite and a test cell including the positive electrode composite were manufactured in the same manner as in Example 1 except for mixing the aqueous solution of the precursor of the mixed-conductivity material and water in a 3:1 ratio and impregnating them on the porous reaction prevention layer (30 wt % of impregnation).

### Example 4

A positive electrode composite and a test cell including the positive electrode composite were manufactured in the same manner as in Example 1 except for using graphite instead of starch as the pore former. The porosity of the porous reaction prevention layer was approximately 35%.

FIG. 2 is a SEM image of a cross-section of the porous reaction prevention layer produced in Example 4. As shown in FIG. 2, an SDC frame structure with pores was obtained.

### Example 5

A positive electrode composite and a test cell including the positive electrode composite were manufactured in the same manner as in Example 1 except for mixing the aqueous solution of the precursor of the mixed-conductivity material and water in a 0.94:1 ratio and impregnating them on the porous reaction prevention layer (9.4 wt % of impregnation).

### Example 6

A positive electrode composite and the test cell including the positive electrode composite were manufactured in the same manner as in Example 1, except for mixing the aqueous solution of the precursor of the mixed-conductivity material and water in a 1.76:1 ratio and impregnating them on the porous reaction prevention layer (17.6 weight % of impregnation).

### Example 7

A positive electrode composite and a test cell including the positive electrode composite were manufactured in the same manner as in Example 1, except for mixing the aqueous solution of the precursor of the mixed-conductivity material and water in 2.11:1 ratio and impregnating them on the porous reaction prevention layer (21.1 wt % of impregnation)

### Example 8

A positive electrode composite and a test cell including the positive electrode composite were manufactured in the same manner as in Example 1, except for mixing the aqueous solution of the precursor of the mixed-conductivity material and water in a 2.45:1 ratio and impregnating them on the porous reaction prevention layer (24.5 wt % of impregnation).

### Comparative Example 1

To manufacture a negative electrode layer in a pellet form, 0.5 g of yttrium-stabilized zirconia (“YSZ”), (Y_{0.2}Zr_{0.8}O₂)—NiO powder (FCM, USA) was added into a mold with a diameter of 1 cm, uniaxially pressed at approximately 200 MPa and calcined at a temperature of 1200° C. for 2 hours.

Ethanol dispersed yttrium-stabilized zirconia was drop coated on the negative electrode layer and sintered at 1400° C. for 4 hours. The manufactured electrolyte layer was 15 μm thick.

Samarium-doped ceria (“SDC”), (Sm_{0.1}Ce_{0.9}O₂) (FCM, USA) was used as a material for the porous reaction prevention layer.

Sm(NO₃)₃, Sr(NO₃)₂ and Co(NO₃)₂ and urea were quantified in accordance with a 0.5:0.5:1.0:3.5 molar ratio. Thereafter, polyvinyl alcohol (“PVA”) was quantified in the same weight as urea. Then, 100 g of all quantified materials were added to a 50 liter (L) reactor equipped with an agitator. Thereafter, 10 L of deionized water was added to the above reactor. Then, the contents in the above reactor were stirred and heated to 200° C. and maintained at that temperature for 3 hours. As a result, a gelled material was obtained. Thereafter, the gelled material was transferred to an aluminum crucible and dried at a temperature of 100° C. for 24 hours in an oven. Thereafter, the dried material was transferred to a furnace and sintered at a temperature of about 1000° C. for 5 hours. The sintered material was pulverized by using a planetary ball mill at 2000 revolutions per minute (rpm) for 24 hours. The milled powder was dried in an oven thereby obtaining the final powder, Sm_{0.5}Sr_{0.5}CoO₃ (“SSC”).

The mixed particles of the manufactured SDC and SSC (3:7 weight ratio) were spray coated on the manufactured electrolyte layer to produce a positive electrode composite layer.

### Comparative Example 2

To manufacture a negative electrode layer in a pellet form, 0.5 g of yttrium-stabilized zirconia (“YSZ”), (Y_{0.2}Zr_{0.8}O₂)—NiO powder (FCM, USA) was added to a mold with a diameter of 1 cm, uniaxially pressed at approximately 200 MPa and calcined at a temperature of about 1200° C. for 2 hours.

Ethanol dispersed yttrium-stabilized zirconia was drop coated on the negative electrode layer and sintered at about 1400° C. for 4 hours. The manufactured electrolyte layer was 15 μm thick.

Sm(NO₃)₃, Sr(NO₃)₂ and Co(NO₃)₂ and urea were quantified in accordance with a 0.5:0.5:1.0:3.5 molar ratio. Thereafter, polyvinyl alcohol (“PVA”) was quantified in the same weight as urea. Then, 100 g of all of the quantified materials were added to a 50 L reactor equipped with an agitator. Thereafter, 10 L of deionized water was added to the above reactor. Then, the contents of the reactor were stirred and heated to about 200° C. and maintained at that temperature for 3 hours. As a result, a gelled material was obtained. Thereafter, the gelled material was transferred to an aluminum crucible and dried at a temperature of 100° C. for 24 hours in an oven. Thereafter, the dried material was transferred to a furnace and sintered at a temperature of about 1000° C. for 5 hours. The sintered material was pulverized by using a planetary ball mill at about 2000 rpm for 24 hours, and the milled powder was dried in an oven, thereby obtaining the final powder, Sm_{0.5}Sr_{0.5}CoO₃.

After adding 0.2 g of an organic vehicle (ink vehicle, VEH, FCM, USA) to 0.3 g of the Sm_{0.5}Sr_{0.5}CoO₃ powder and mixing them uniformly to manufacture a slurry, the slurry was used to screen print (used 40 μm screen) on the reaction prevention layer comprising SDC (Sm_{0.1}Ce_{0.9}O₂) (FCM, USA), on both sides. Then, the reaction prevention layer was sintered at a temperature of 900° C. for 2 hours to produce the positive electrode layers on both sides of the reaction prevention layer.

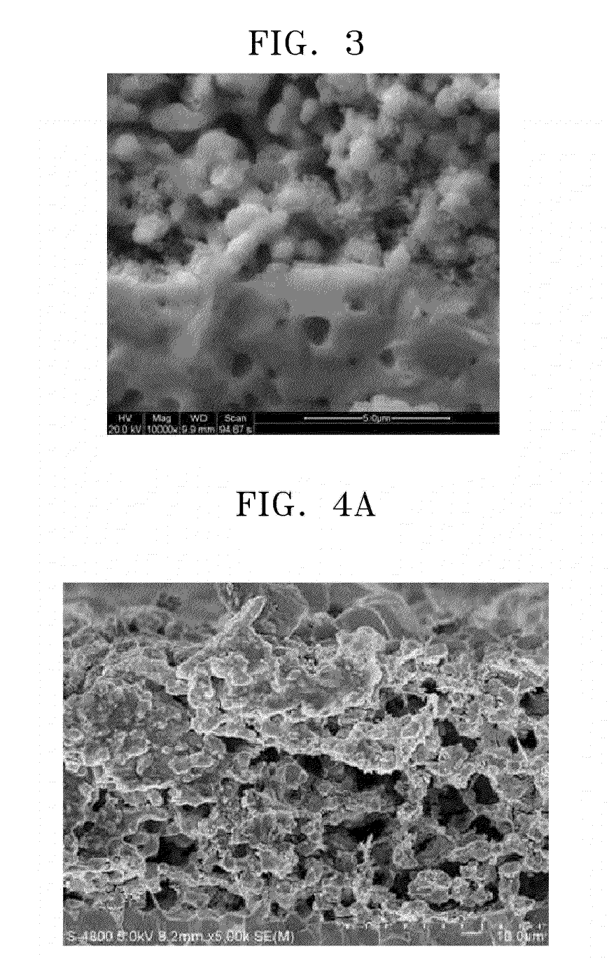

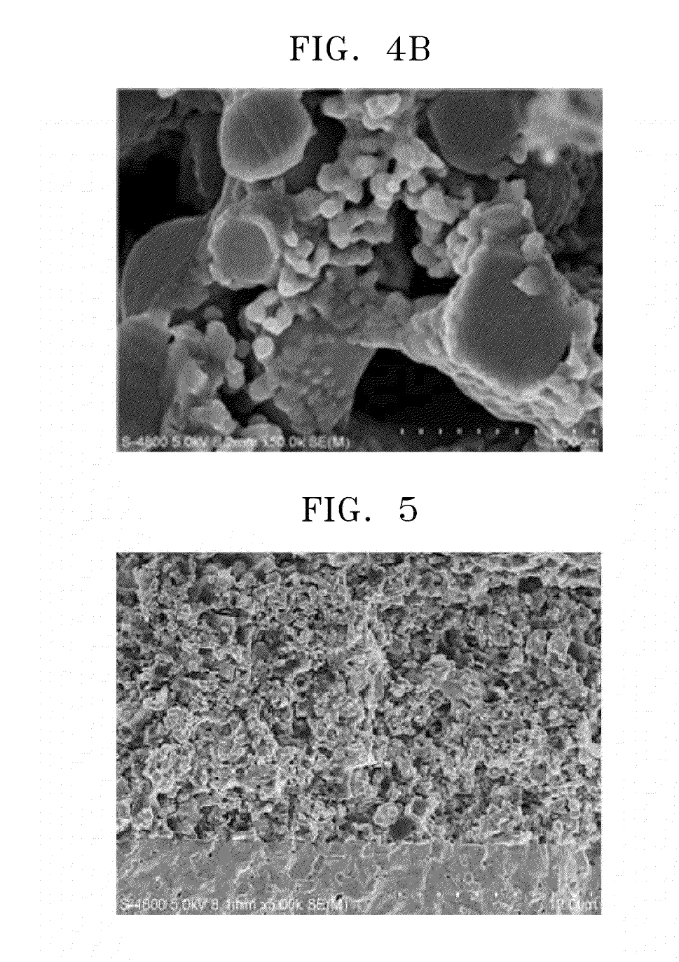

FIG. 3 and FIG. 4 are scanning electron microscope images of a cross-section of the positive electrode composite layers manufactured in Example 1 and Example 2, respectively. FIG. 4B is a magnified image of FIG. 4A by 10 times.

As shown in FIG. 3 and FIG. 4, SSC particles, which are mixed-conductivity material, were well formed in the pores within a SDC frame of the reaction prevention layer. The mixed-conductivity material had small and uniform particles with an average diameter of 100 nm or less.

FIG. 5 is a scanning electron microscope image, showing a cross-section of the positive electrode composite manufactured in the Comparative Example 1. As shown in FIG. 5, particles of the mixed-conductivity material and the reaction prevention materials were uniformly mixed.

### Evaluation Example 1

### Thermal Expansion Coefficient Measurement Test

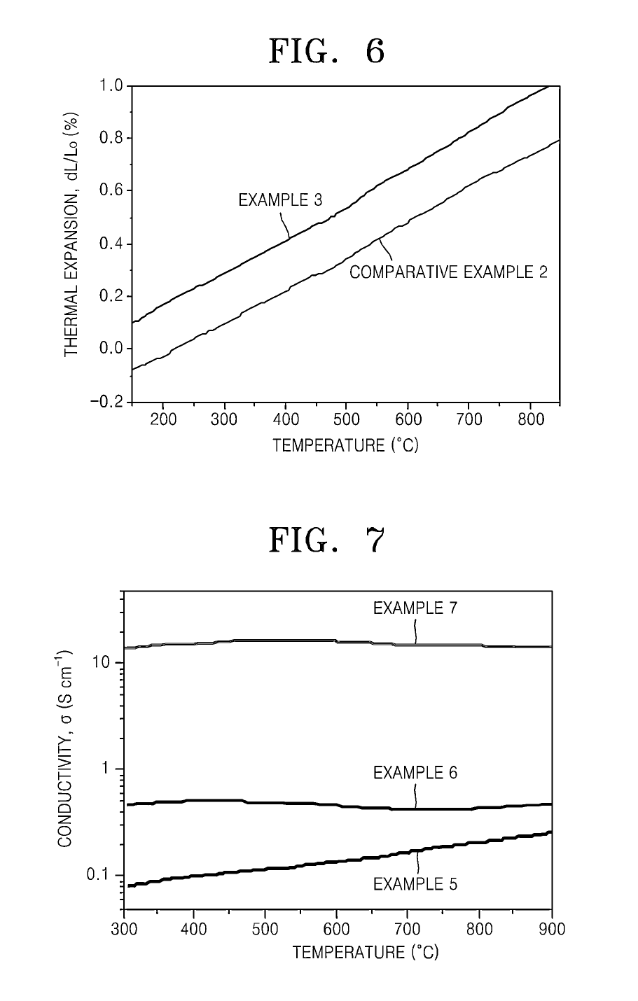

The thermal expansion coefficient of the positive electrode composite manufactured in the Example 3 was measured in air atmosphere and the result was represented in Table 1. A DIL402PC NETZSCH instrument was used to measure the thermal expansion coefficient. Also, the thermal expansion coefficients of the porous reaction prevention layer itself in Example 3 and the positive electrode layer in Comparative Example 2 were measured and represented in Table 1 and FIG. 6.

TABLE 1

| | Thermal expansion |
|---|---|
| | coefficient (×10⁻⁶ K⁻¹) |
| Positive electrode composite of Example 3 | 13.28 |
| Porous reaction prevention layer itself in | 12.74 |
| Example 3 | |
| Positive electrode layer in Comparative | 22.8 |
| Example 2 | |

As shown in Table 1 and FIG. 6, the thermal expansion coefficient of the positive electrode composite, according to an embodiment, decreased compared to a traditional positive electrode layer and slightly increased compared to the porous reaction prevention layer without the impregnation of the mixed-conductivity material. Thus, since the thermal expansion coefficient did not change much, cells with an excellent durability may be obtained by impregnating the mixed-conductivity material on the porous reaction prevention layer.

### Evaluation Example 2

### Electrical Conductivity Measurement Test

The electrical conductivity of SDC layer impregnated with the SSC manufactured in Examples 5 to 7 was measured by a 4 probe DC method and the result is shown in FIG. 7.

FIG. 7 shows a graph of the electrical conductivity versus the temperature at different SSC impregnation values.

As shown in FIG. 7, the positive electrode composite layer, according to an embodiment, has an electrical conductivity that allows it to be used as a positive electrode. A rapid increase in the electrical conductivity of the positive electrode composite layer in Example 7 may indicate that SSC, which is a mixed-conductivity material, was connected within the SDC frame structure.

### Evaluation Example 3

### Ion Resistance and Resistance Stability Measurement Tests in an Air Atmosphere

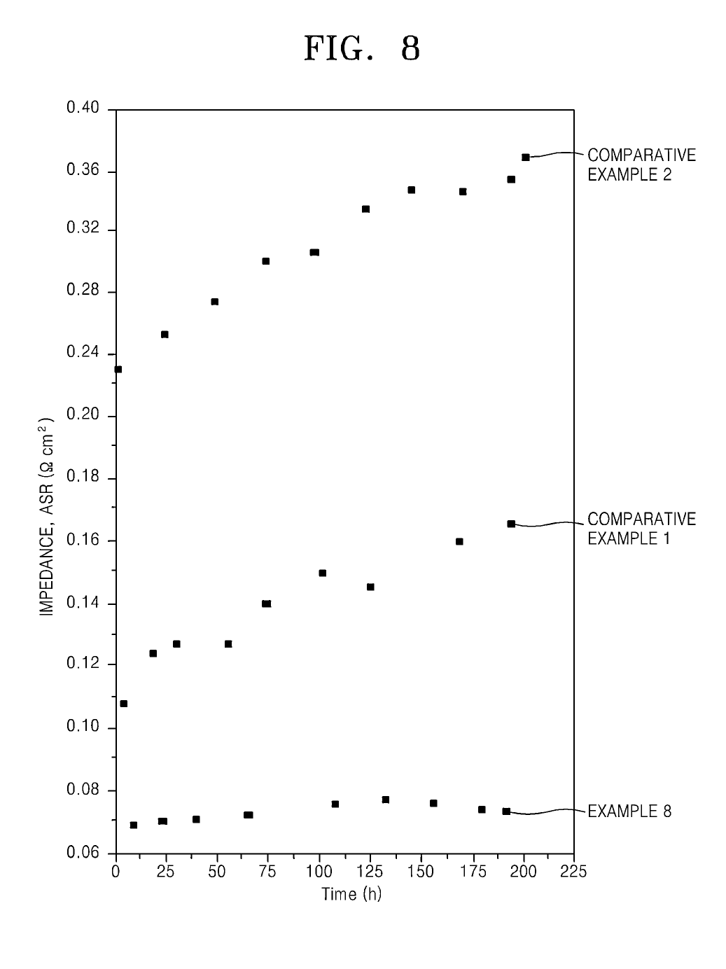

The impedance (i.e., area specific resistance, “ASR”) of test cells manufactured in Example 8, Comparative Examples 1 and 2 was measured in an air atmosphere and the results are shown in Tables 2 below and FIG. 8. A Materials mates 7260 from the Material mates company was used as an impedance measurement instrument. Also, the operating temperature of the test cells was maintained at a temperature of about 700° C.

Also, to measure the resistance stability, the impedance change was measured and evaluated for 200 hours.

TABLE 2

| | (Ω cm² @700° C.) |
|---|---|
| Example 8 | 0.07 |
| Comparative Example 1 | 0.10 |
| Comparative Example 2 | 0.23 |

As shown in Table 2 and FIG. 8, in the case of the test cells that contained the positive electrode composite according to an embodiment of, the resistance at a low temperature was lower than or similar to the resistance of the test cells of Comparative Examples 1 and 2. Hence, these test cells according to the present disclosure have higher or similar ion conductivity compared to the test cells of Comparative Examples 1 and 2.

Also, as shown in FIG. 8, the test cells that comprised the positive electrode composite according to an embodiment, showed almost no resistance change for 200 hours at 70° C., which indicates that these cells have excellent durability.

### Evaluation Example 4

### The Measurement of Current-Voltage and Output Density

The measurement of I-V/I-P, wherein, I represents current, V represents voltage, and P represents power density, was performed for a unit cell including the positive electrode composite in Example 8 and Comparative Examples 1 and 2 respectively. YSZ—NiO was used as a negative electrode.

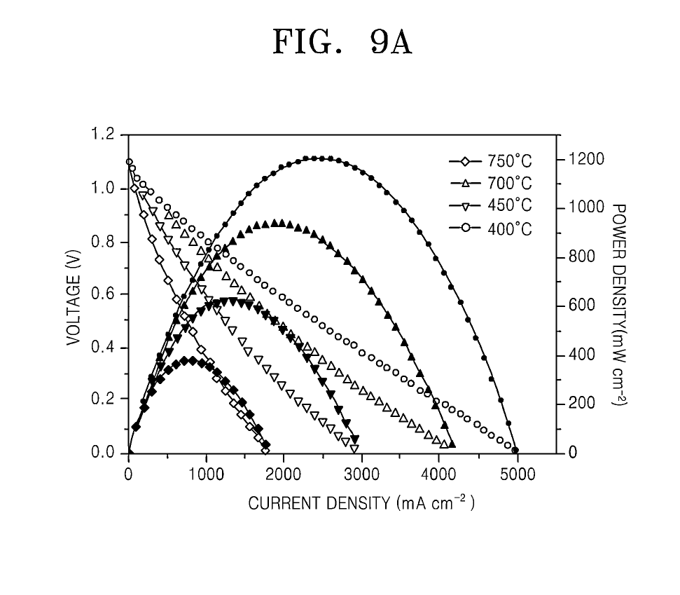

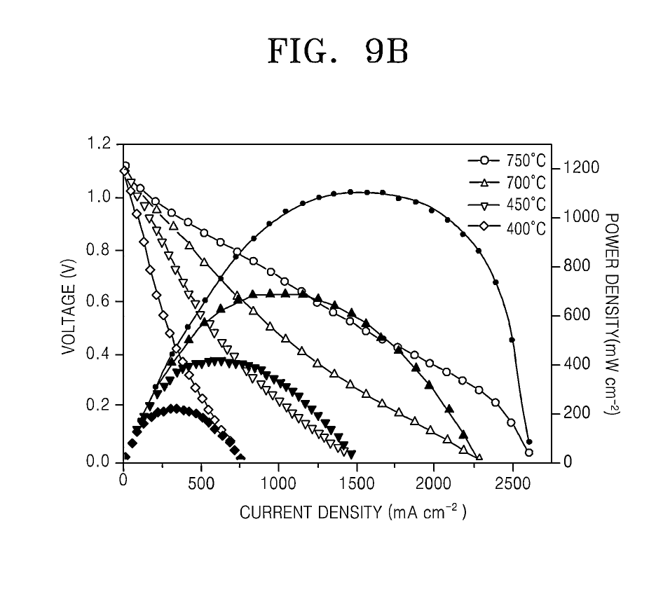

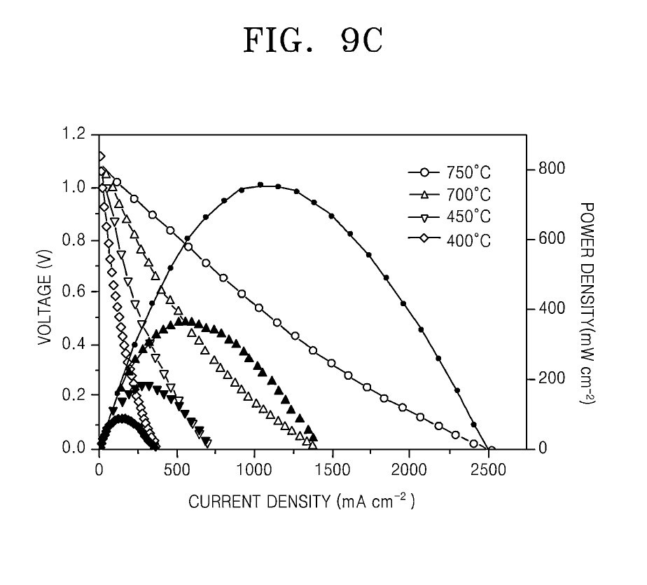

When oxygen was introduced into an air electrode (positive electrode), hydrogen gas was introduced into a fuel electrode (negative electrode), and thus, an open circuit voltage (“OCV”) of 1V or more could be obtained. To obtain I-V data, a voltage-drop was measured by increasing the current from 0 A (Ampere) to several A. The current was increased until the voltage became 0V. I-P could be obtained by calculating from the I-V data. I-V and I-P measurement results are shown in FIG. 9. White dots in FIG. 9 are a graph showing the I-V relationship at each measuring temperature and black dots are a graph showing the calculated output density from the I-V graph. FIG. 9A relates to Example 8, FIG. 9B relates to Comparative Example 1 and FIG. 9C relates to Comparative Example 2.

As shown in FIG. 9, the unit cell that comprised the positive electrode composite according to an embodiment, showed an excellent output density performance even at a low temperature.

As described above, according to an embodiment, a positive electrode composite for a solid oxide fuel cell with excellent frame stability may have long term durability even after a long term use, and a solid oxide fuel cell with high reliability and excellent output density at a low temperature may be obtained.

It should be understood that the exemplary embodiments described therein should be considered in a descriptive sense only and not for purposes of limitation. Descriptions of the features or aspects within each embodiment should typically be considered as available for other similar features, advantages, or aspects in other embodiments.

What is claimed is:

1. A positive electrode composite for a solid oxide fuel cell, the positive electrode composite comprising:
a porous reaction prevention layer; and
a mixed-conductivity material disposed in the porous reaction prevention layer.

2. The positive electrode composite of claim 1, wherein a porosity of the porous reaction prevention layer is in a range of about 35 percent to about 60 percent.

3. The positive electrode composite of claim 1, wherein an average pore size of the porous reaction prevention layer is about 200 nanometers to about 1 micrometer.

4. The positive electrode composite of claim 1, wherein an average diameter of the mixed-conductivity material is about 100 nanometers or less.

5. The positive electrode composite of claim 1, wherein the mixed-conductivity material comprises a perovskite metal oxide of Formula 1:
AMO_{3±γ} Formula 1
wherein, A is selected from La, Ba, Sr, Sm, Gd, and Ca, M is selected from Mn, Fe, Co, Ni, Cu, Ti, Nb, Cr, and Sc, γ denotes oxygen excess or oxygen shortage, and 0≦γ≦0.3.

6. The positive electrode composite of claim 5, wherein the mixed-conductivity material comprises a perovskite metal oxide of Formula 2:
A′₁₋ₓA″ₓM′O_{3±γ} Formula 2
wherein, A′ is at least one element of Ba, La, and Sm,
A″ is selected from Sr, Ca, and Ba and is different from A′,
M′ is selected from Mn, Fe, Co, Ni, Cu, Ti, Nb, Cr, and Sc, 0≦x≦1, γ denotes oxygen excess or oxygen shortage and 0≦γ≦0.3.

7. The positive electrode composite of claim 1, wherein the mixed-conductivity material comprises a perovskite a metal oxide of Formula 3:
BaₐSr_{b}CoₓFe_{y}Z_{1-x-y}O_{3±γ} Formula 3
wherein, 0.4≦a≦0.6, 0.4≦b≦0.6, 0.6≦x<0.9, 0.1≦y≦0.4, x+y<1, γ denotes oxygen excess or oxygen shortage and 0≦γ0.3, and Z is at least one element selected from transition metal elements and lanthanum group elements.

8. The positive electrode composite of claim 5, wherein the perovskite metal oxide is at least one of barium strontium cobalt iron oxide, lanthanum strontium cobalt oxide, lanthanum strontium cobalt iron oxide, lanthanum strontium cobalt manganese oxide, lanthanum strontium iron oxide, and samarium strontium cobalt oxide.

9. The positive electrode composite of claim 6, wherein the perovskite metal oxide is at least one of Ba₁₋ₓSrₓCo_{1-y}Fe_{y}O_{3±γ} wherein, 0.1≦x≦0.5, 0.05≦y≦0.5, and 0≦γ≦0.3, La₁₋ₓSrₓFe_{1-y}Co_{y}O_{3±γ} wherein, 0.1≦x≦0.4, 0.05≦y≦0.5, and 0≦γ≦0.3 and Sm₁₋ₓSrₓCoO_{3±γ} wherein, 0.1≦x≦0.5, and 0≦γ≦0.3.

10. The positive electrode composite of claim 9, wherein the perovskite metal oxide is Ba_{0.5}Sr_{0.5}CoO_{0.8}Fe_{0.2}O₃, La_{0.8}Sr_{0.4}CoO_{0.2}Fe_{0.8}O₃, or Sm_{0.5}Sr_{0.5}CoO₃.

11. The positive electrode composite of claim 7, wherein the perovskite metal oxide comprises a compound of Formula 4:
Ba_{0.5}Sr_{0.5}CoₓFe_{y}Z_{1-x-y}O_{3±γ}, Formula 4
wherein Z is at least one of a transition metal element and a lanthanum group element, x and y each have a range of 0.75≦x≦0.85, 0.1≦y≦0.15, respectively, 0≦γ≦0.3, and x+y<1.

12. The positive electrode composite of claim 7, wherein x and y of Formula 3 are in a range of 0.7≦x+y≦0.95.

13. The positive electrode composite of claim 7, wherein a and b of Formula 3 are in a rage of 0.9≦a+b≦1.

14. The positive electrode composite of claim 7, wherein Z of Formula 3 is at least one of a transition metal element comprising manganese, zinc, nickel, titanium, niobium, and copper.

15. The positive electrode composite of claim 7, wherein Z of Formula 3 is at least one of a lanthanum group element comprising holmium, ytterbium, erbium, and thulium.

16. The positive electrode composite of claim 1, wherein a thickness of the positive electrode composite is about 1 micrometer to about 100 micrometers.

17. The positive electrode composite of claim 1, wherein an amount of the mixed-conductivity material is about 20 weight percent to about 50 weight percent, based on a total weight of the positive electrode composite.

18. The positive electrode composite of claim 1, wherein the positive electrode composite comprises at least one of gadolinium-doped ceria, samarium-doped ceria, and yttrium-doped ceria.

19. A method of manufacturing a positive electrode composite for a solid oxide fuel cell, the method comprising:
providing a solution comprising a precursor of a mixed-conductivity material;
disposing the solution on a porous reaction prevention layer to impregnate the porous reaction prevention layer with the precursor of the mixed-conductivity material; and
heat treating the porous reaction prevention layer impregnated with the precursor of the mixed-conductivity material to manufacture the positive electrode composite.

20. The method of claim 19, wherein the precursor of the mixed-conductivity material is selected from a nitride, an oxide, and a halide of the metal of the mixed-conductivity material.

21. The method claim 19, wherein the porous reaction prevention layer is prepared by
adding a pore former to a reaction prevention layer material to provide a mixture, and
calcining the mixture.

22. The method of claim 21, wherein the pore former comprises at least one of starch, polyvinylbutyral, and graphite.

23. The method of claim 21, wherein the pore former is added to the reaction prevention layer material in an amount of about 5 parts by weight to about 20 parts by weight per 100 parts by weight of the reaction prevention layer material.

24. The method of claim 19, wherein the heat treatment is performed at a temperature of about 1100° C. to about 1400° C.

25. The method of claim 21, wherein the calcination is performed at a temperature of about 900° C. to about 1100° C.

26. The method of claim 19, wherein an amount of the precursor of the mixed-conductivity material used is such that the amount of the mixed-conductivity material in the positive electrode composite is in a range of about 20 weight percent to about 50 weight percent, based on a total weight of the positive electrode composite.

27. A solid oxide fuel cell comprising: the positive electrode composite of claim 1; a negative electrode; and an electrolyte disposed between the positive electrode composite and the negative electrode.
